(19) United States
(12) Patent Application Publication
(10) Pub. No.: US 2022/0372198 A1
(43) Pub. Date: Nov. 24, 2022

(54) Polypropylene Composition And Molded Article

(71) Applicant: BASELL POLIOLEFINE ITALIA S.R.L., MILANO (IT)

(72) Inventors: Yutaka Yokoyama, Kanagawa (JP); Akihiro Kamimura, Kanagawa (JP); Hiroshi Kajioka, Kanagawa (JP)

(73) Assignee: BASELL POLIOLEFINE ITALIA S.R.L., MILANO (IT)

(21) Appl. No.: 17/771,667

(22) PCT Filed: Oct. 22, 2020
(86) PCT No.: PCT/JP2020/040546

§ 371 Date: Apr. 25, 2022

(30) Foreign Application Priority Data
Oct. 24, 2019 (JP) 2019-193700

(51) Int. Cl. C08F 297/08

(52) U.S. Cl. CPC C08F 297/083

(57) ABSTRACT

A polypropylene composition made from or containing

a first polymer consisting of
component (1) made from or containing a propylene homopolymer having an MFR of 80 to 300 and containing 97.5% by weight or more of xylene insolubles (XI), wherein XI of the propylene homopolymer has a Mw/Mn of 4 to 10; and
component (2) made from or containing an ethylene/propylene copolymer containing 35 to 50% by weight of an ethylene-derived unit;
   wherein the polypropylene composition has the following characteristics:
1) the relative proportions of component (2)/[component (1) and component (2)] is more than 30% by weight and not more than 50% by weight,
2) the intrinsic viscosity of xylene solubles (XSIV) of the first polymer is in the range of 1.5 to 4.0 dl/g, and
3) the MFR of the first polymer is in the range of 20 to 100 g/10 min.

### FIELD OF THE INVENTION

In general, the present disclosure relates to the field of chemistry. More specifically, the present disclosure relates to polymer chemistry. In particular, the present disclosure relates to a polypropylene composition and a molded product.

### BACKGROUND OF THE INVENTION

Polypropylene is used in various applications. However, for use as an automobile interior material, there is a desire to produce a polypropylene composition having higher stiffness, higher melt flowability, and higher impact resistance at low temperature.

### DETAILED DESCRIPTION OF THE INVENTION

In a general embodiment, the present disclosure provides

[1] a polypropylene composition made from or containing

a first polymer consisting of
component (1) made from or containing a propylene homopolymer having an MFR of 80 to 300 g/10 min (at a temperature of 230° C. under a load of 2.16 kg) and containing 97.5% by weight or more of xylene insolubles (XI), wherein XI of the propylene homopolymer has an Mw/Mn of 4 to 10 as measured by GPC; and
component (2) made from or containing an ethylene/propylene copolymer containing 35 to 50% by weight of an ethylene-derived unit;
   wherein the polypropylene composition has the following characteristics:
1) the relative proportion of component (2)/[component (1) and component (2)] is, more than 30% by weight and not more than 50% by weight,
2) the intrinsic viscosity of xylene solubles (XSIV) of the first polymer is in the range of 1.5 to 4.0 dl/g, and
3) the MFR (at a temperature of 230° C. under a load of 2.16 kg) of the first polymer is in the range of 20 to 100 g/10 min.
   [2] In some embodiments,
component (1) is porous particles having an average particle size of 1.5 to 4.0 mm and an average pore diameter (Dn) of 8 to 50 μm; and
the first polymer is a powder, wherein the flowability of the powder is 3.5 or less.
   [3] In some embodiments, a pellet-shaped polypropylene composition is produced from the polypropylene composition.
   [4] In some embodiments, a molded article is obtained by injection molding the polypropylene composition.

As used herein, the phrase “X to Y” includes the end values X and Y.

### 1. Polypropylene Composition

In some embodiments, the polypropylene composition is made from or containing a first polymer consisting of component (1) and component (2).

In some embodiments, Component (1) is made from or containing a propylene homopolymer having an MFR of 80 to 300 g/10 min (at a temperature of 230° C. under a load of 2.16 kg), containing 97.5% by weight or more of xylene insolubles (XI), wherein the XI has an Mw/Mn of 4 to 10 as measured by GPC.

In some embodiments, Component (2) is made from or containing an ethylene/propylene copolymer containing 35 to 50% by weight of an ethylene-derived unit.

(1) Component (1)

In some embodiments, Component (1) is made from or containing a propylene homopolymer having an MFR of 80 to 300 g/10 min (at a temperature of 230° C. under a load of 2.16 kg), containing 97.5% by weight or more of xylene insolubles (XI), wherein the XI has an Mw/Mn of 4 to 10 as measured by GPC. In some embodiments, the propylene homopolymer is made from or containing less than 0.5% by weight of monomer units other than propylene, arising from a recycled gas, or the like generated in production of the polymer containing a copolymer component. It is believed that an MFR of component (1) equal to or more than the lower limit of the range provides melt flowability. It is also believed that an MFR of component (1) equal to or less than the upper limit provides impact resistance. In some embodiments, the MFR of component (1) is in the range of 90 to 300 g/10 min, alternatively 100 to 300 g/10 min, alternatively 150 to 300 g/10 min, alternatively 180 to 300 g/10 min. It is believed that a content of XI of equal to or more than the lower limit of the range provides balance among mechanical properties such as the stiffness and the impact resistance of the composition. In some embodiments, the XI is 98.0% by weight or more, alternatively 98.3% by weight or more. It is believed that an Mw/Mn, as measured by GPC, of XI equal to or more than the lower limit of the range minimizes the occurrence of defects such as flow marks and silver streaks on the surface of a molded article. It is also believed that an Mw/Mn equal to or less than the upper limit of the range provides impact resistance. In some embodiments, Mw/Mn is in the range of 4 to 8, alternatively 5 to 7.

In some embodiments, Component (1) is a powder, and the particles thereof have an average particle size (diameter) of 1.5 to 4.0 mm, alternatively 1.5 to 3.0 mm. The average particle size is an arithmetic average diameter of particles photographed by the optical microscopic method defined in JIS Z8901. In some embodiments, the number of particles per gram is measured to determine the average weight per piece and the average volume per piece is determined from the bulk density, thereby the average particle size is obtained as the average diameter of spheres from the average volume. In some embodiments, the bulk density is measured by dividing the volume (bulk volume) of component (1) placed in a sealed container by the weight.

In some embodiments, component (1) is made of porous particles having an average pore diameter Dn of 8 to 50 μm. Dn is an average of pore diameters D measured by the mercury porosimetry according to JIS R1655. It is believed that a Dn in the range provides improved powder flowability. In some embodiments, Dn is in the range of 8 to 30 μm, alternatively 8 to 15 μm.

(2) Component (2)

In some embodiments, Component (2) is made from or containing an ethylene/propylene copolymer, containing 35 to 50% by weight of ethylene-derived units. In some embodiments, the upper limit of the content of ethylene-derived units is 50% by weight or less, alternatively 48% by weight or less. As used herein, the term “powder flowability” refers to (a) flowability of powder first polymer consisting of component (1) and component (2) produced in a polymerization reactor and (b) an index of the production stability of the polymer. It is believed that a content of ethylene-derived units beyond the upper limit adversely affects the powder flowability and reduces the production stability. In some embodiments, the lower limit of the content of the ethylene-derived units is 35% or more, alternatively 40% by weight or more, alternatively 43% by weight. It is believed that a content of ethylene-derived units less than the lower limit reduces the impact resistance at low temperature.

(3) Composition Ratio

In some embodiments and regarding the composition ratio (weight ratio) between component (1) and component (2), the relative proportion of component (2)/[component (1) and component (2)] is more than 30% by weight and not more than 50% by weight; alternatively more than 30% by weight and not more than 45% by weight, alternatively 33% to 45% by weight. It is believed that a content of component (1) more than the upper limit reduces the impact resistance. It is believed that a content of component (1) less than the lower limit adversely affects the powder flowability deteriorates and reduces the production stability.

(4) Characteristics of Polymer Consisting of Component (1) and Component (2)

1) XSIV

The intrinsic viscosity (XSIV) of xylene solubles (XS) of the first polymer consisting of component (1) and component (2) is an index of the molecular weight of the components having non-crystallinity in the first polymer. XSIV is determined by obtaining components soluble in xylene at 25° C. and measuring the intrinsic viscosity of the components. In some embodiments, XSIV is in the range of 1.5 to 4.0 dl/g, alternatively 1.5 to 3.5 dl/g, alternatively 1.5 to 3.0 dl/g, alternatively 1.5 to 2.7 dl/g. It is believed that an XSIV more than the upper limit reduces the melt flowability. It is also believed that an XSIV less than the lower limit reduces the impact resistance, adversely affect the powder flowability, and reduces the production stability.

2) MFR

In some embodiments, MFR of the first polymer consisting of component (1) and component (2) is measured at a temperature of 230° C. under a load of 2.16 kg, is in the range of 20 to 100 g/10 min, alternatively 25 to 60 g/10 min, alternatively 28 to 50 g/10 min. It is believed that an MFR more than the upper limit reduces the impact resistance. It is also believed that an MFR less than the lower limit reduces the capability of injection molding of the composition.

3) Structure and the Like

In some embodiments, the polypropylene composition is made from or containing a first polymer consisting of components (1) and (2), and other components such as additives and fillers. In some embodiments, the first polymer consisting of components (1) and (2) has a structure wherein component (2) is dispersed in component (1), such that component (2) is held in pores of component (1). In some embodiments, component (2) is a viscoelastic material held in the pores of component (1) as porous particles, and the polymer is in a powder form. In some embodiments, the powder has a powder flowability of 3.5 or less. As previously noted, powder flowability is the flowability of a powder polymer produced in a polymerization reactor, and an index of the production stability of the polymer. Specifically, the powder flowability is a quantified value of the flowability of powder, when the powder on a substrate flows on a tilted substrate after removal of a specific load applied to the powder placed on the substrate at a specific temperature for a specific time. As the value of powder flowability decreases, the powder flowability improves, thereby improving the production stability. In some embodiments, the powder flowability of the first polymer is 3.5 or less, alternatively 3.0 or less, alternatively 2.0 or less.

The powder flowability was measured by the following method.

On a metal substrate (first substrate), a frame having an opening with a length of 5 cm, a width of 5 cm, and a height of 1 cm was placed. In the frame, 5 g of powder first polymer consisting of components (1) and (2) was spread. A second substrate is placed on the frame, such that a uniform pressure of 23 g/cm² was applied to the powder. After the powder in the frame was held at 70° C. for 20 minutes, the frame and the second substrate were removed. The first substrate was tilted to evaluate the degree of collapse of the powder based on the following criteria.

1: The total volume of powder collapsed when the substrate was tilted at 0° or more and less than 30°.

2: The total volume of powder collapsed when the substrate was tilted at 300 or more and less than 50°.

3: The total volume of powder collapsed when the substrate was tilted at 500 or more and less than 70°.

4: The total volume of powder collapsed when the substrate was tilted at 700 or more and less than 90°.

5: No total volume collapse occurred even when the substrate was tilted at 900 or more.

In some embodiments, the first substrate and the second substrate are made of stainless steel. In some embodiments, the first substrate has a surface roughness (maximum roughness Ry) of 1 μm or less, thereby preventing friction with the powder.

(5) Other Components

In some embodiments, the polypropylene composition is further made from or containing additives. In some embodiments, the additives are selected from the group consisting of antioxidants, chlorine absorbers, heat-resistant stabilizers, light stabilizers, ultraviolet absorbers, internal lubricants, external lubricants, antiblocking agents, antistatic agents, antifogging agents, flame retardants, dispersants, nucleating agents, copper inhibitors, neutralizers, plasticizers, defoaming agents, crosslinking agents, oil extensions, and other organic and inorganic pigments. In some embodiments, the polypropylene composition is further made from or containing one or more resins or elastomers.

In some embodiments, the polypropylene composition is further made from or containing fillers as components other than the additives. In some embodiments, the fillers improve the stiffness of the material. In some embodiments, the fillers are inorganic fillers selected from the group consisting of talc, clay, calcium carbonate, magnesium hydroxide and glass fiber. In some embodiments, the filler is talc. In some embodiments, the fillers are organic fillers selected from the group consisting of carbon fiber and cellulose fiber. In some embodiments, the fillers are subjected to surface treatment. In some embodiments, a master batch of a filler and a resin are prepared.

(6) Pellet

In some embodiments, the polypropylene composition is in a powder form. In some embodiments, pellets are formed through melting and kneading from the powder. As used herein, the term “pellet” refers to a pelletized article having a certain shape such as a spherical, ellipsoid, cylindrical, or prism shape. In some embodiments, the pellets are made by melting and kneading the powder first polymer and then extruding the first polymer for cutting by a cutter or pelletizer. In some embodiments, the weight per particle is 10 to 40 mg. In some embodiments, other components are added to the polymers to constitute the polypropylene composition in granulation. In some embodiments and after granulation, the pellets are blended with other components, thereby yielding the polypropylene composition.

2. Production Method

In some embodiments, the first polymer is produced by polymerizing a raw material monomer of component (1) and raw material monomers of component (2) using two or more reactors. In some embodiments, a raw material monomer of component (1) is polymerized, thereby producing a homopolymer of component (1), and raw material monomers of component (2) is polymerized in the presence of the homopolymer, thereby producing a copolymer. In some embodiments, the polymerization of component (1) and component (2) occurs in a liquid phase, a gas phase or a liquid-gas phase.

In some embodiments, a Ziegler-Natta catalyst consisting of (a) a solid catalyst containing magnesium, titanium, a halogen, and an internal electron donor; (b) an organoaluminum compound; and optionally, (c) an external electron donor is used in the polymerization. In some embodiments, a metallocene catalyst is used in the polymerization.

(1) Solid Catalyst (Component (a))

In some embodiments, Component (a) is prepared by bringing a magnesium compound, a titanium compound and an electron donor compound into contact with each other. In some embodiments, the conditions for contact among the compounds contained in the component and the conditions for precipitation are adjusted, depending on the constituent components of the solid catalyst, the types of solvent and dispersant selected, the temperature of solvent, and the stirring rate, thereby controlling the average diameter (average particle size) and the average pore diameter of the resulting catalyst particles. In some embodiments, the polymer particle has a figure similar to the catalyst particle, thereby controlling the shape of the catalyst particle and maintaining the average particle size (diameter) and the average pore diameter (Dn) of the propylene homopolymer (component (1)) in specific ranges.

In some embodiments, the titanium compound for use in preparation of component (a) is a tetravalent titanium compound represented by general formula: Ti(OR)_{g}X_{4-g}. In some embodiments, R represents a hydrocarbon group and X represents a halogen, and 0≤g≤4. In some embodiments, the titanium compound is selected from the group consisting of tetra-halogenated titanium compound; a tri-halogenated alkoxytitanium; di-halogenated alkoxytitanium; a mono-halogenated tri-alkoxytitanium; and tetra-alkoxytitanium. In some embodiments, the tetra-halogenated titanium compound is selected from the group consisting of TiCl₄, TiBr₄ and TiI₄. In some embodiments, the tri-halogenated alkoxytitanium is selected from the group consisting of Ti(OCH₃)Cl₃, Ti(OC₂H₅)Cl₃, Ti(Oₙ—C₄H₉)Cl₃, Ti(OC₂H₅)Br₃ and Ti(OisoC₄H₉)Br₃. In some embodiments, the di-halogenated alkoxytitanium is selected from the group consisting of Ti(OCH₃)₂Cl₂, Ti(OC₂H₅)₂Cl₂, Ti(Oₙ—C₄H₉)₂Cl₂ and Ti(OC₂H₅)₂Br₂. In some embodiments, the mono-halogenated tri-alkoxytitanium is selected from the group consisting of Ti(OCH₃)₃Cl, Ti(OC₂H₅)₃Cl, Ti(Oₙ—C₄H₉)₃Cl and Ti(OC₂H₅)₃Br. In some embodiments, the tetra-alkoxytitanium is selected from the group consisting of Ti(OCH₃)₄, Ti(OC₂H₅)₄ and Ti(Oₙ—C₄H₉)₄. In some embodiments, the halogen-containing titanium compound is a tetra-halogenated titanium. In some embodiments, the halogen-containing titanium compound is titanium tetrachloride.

In some embodiments, the magnesium compound for use in preparation of component (a) is a magnesium compound having a magnesium-carbon bond or a magnesium-hydrogen bond. In some embodiments, the magnesium compound is selected from the group consisting of dimethylmagnesium, diethylmagnesium, dipropylmagnesium, dibutylmagnesium, diamylmagnesium, dihexylmagnesium, didecylmagnesium, ethylmagnesium chloride, propylmagnesium chloride, butylmagnesium chloride, hexylmagnesium chloride, amylmagnesium chloride, butylethoxy magnesium, ethylbutyl magnesium and butylmagnesium hydride. In some embodiments, the magnesium compounds are in a form of complex compound with organoaluminium. In some embodiments, the magnesium compounds are in a liquid form or a solid form. In some embodiments, the magnesium compound is selected from the group consisting of halogenated magnesiums, alkoxymagnesium halides, aryloxymagnesium halides, alkoxymagnesiums, aryloxymagnesiums, and carboxylates of magnesium. In some embodiments, the halogenated magnesium is selected from the group consisting of magnesium chloride, magnesium bromide, magnesium iodide and magnesium fluoride. In some embodiments, the alkoxymagnesium halide is selected from the group consisting of methoxymagnesium chloride, ethoxymagnesium chloride, isopropoxymagnesium chloride, butoxymagnesium chloride and octoxymagnesium chloride. In some embodiments, the aryloxymagnesium halide is selected from the group consisting of phenoxymagnesium chloride and methylphenoxy magnesium chloride. In some embodiments, the alkoxymagnesium is selected from the group consisting of ethoxymagnesium, isopropoxymagnesium, butoxymagnesium, n-octoxymagnesium and 2-ethylhexoxymagnesium. In some embodiments, the aryloxymagnesium is selected from the group consisting of phenoxymagnesium and dimethylphenoxy magnesium. In some embodiments, the carboxylate of magnesium is selected from the group consisting of magnesium laurate and magnesium stearate.

As used herein, the electron donor compound for use in preparation of compound (a) is referred to as “internal electron donor compound”. In some embodiments, the electron donor compound is selected from the group consisting of a phthalate compound, a succinate compound, a diether compound, a diphenyl dicarboxylate, a cyclohexene dicarxylate, a dicycloalkyl dicarxylate, a diol dibenzoate, and a 1,2-phenylene dibenzoate. In some embodiments, the diphenyl dicarboxylate is as described in Japanese Patent Publication No. JP 2013-28704A. In some embodiments, the cyclohexene dicarxylate is as described in Japanese Patent Publication No. JP 2014-201602A. In some embodiments, the dicycloalkyl dicarxylate is as described in Japanese Patent Publication No. JP 2013-28705A. In some embodiments, the diol dibenzoate as described in Japanese Patent Publication No. JP 4959920B. In some embodiments, the 1,2-phenylene dibenzoate is as described in Patent Cooperation Treaty Publication No. WO 2010/078494.

(2) Organoaluminium Compound (Component (b))

In some embodiments, the organoaluminium compound of component (b) is selected from the group consisting of trialkylaluminums, trialkenylaluminums, dialkylaluminum alkoxides, alkyl aluminum sesquialkoxides, partially halogenated alkylaluminums, dialkylaluminum hydrides, partially hydrogenated alkylaluminums, and partially alkoxylated and halogenated alkylaluminums.

In some embodiments, the trialkylaluminum is selected from the group consisting of triethyl aluminum and tributyl aluminum.

In some embodiments, the trialkenylaluminum is triisoprenylaluminum.

In some embodiments, the dialkylaluminum alkoxide is selected from the group consisting of diethylaluminum ethoxide and dibutylaluminum butoxide.

In some embodiments, the alkyl aluminum sesquialkoxide is selected from the group consisting of ethyl aluminum sesquiethoxide and butyl aluminum sesquibutoxide.

In some embodiments, the partially halogenated alkylaluminum is selected from the group consisting of ethylaluminum dichloride, propylaluminum dichloride, butylaluminum dibromide, diethylaluminum chloride, dipropylaluminum chloride, and dibutylaluminum chloride.

In some embodiments, the dialkylaluminum hydride is selected from the group consisting of diethylaluminum hydride and dibutylaluminum hydride.

In some embodiments, the partially hydrogenated alkylaluminum is an alkylaluminum dihydride. In some embodiments, the alkylaluminum dihydride is selected from the group consisting of ethylaluminum dihydride and propylaluminum dihydride.

In some embodiments, the partially alkoxylated and halogenated alkylaluminum is selected from the group consisting of ethylaluminum ethoxy chloride, butylaluminum butoxy chloride, and ethylaluminum ethoxy bromide.

(3) Electron Donor Compound (Component (c))

As used herein, the electron donor compound of component (c) is referred to as “external electron donor compound”. In some embodiments, the external electron donor compound is an organosilicon compound. In some embodiments, the organosilicon compound is selected from the group consisting of trimethylmethoxysilane, trimethylethoxysilane, dimethyldimethoxysilane, dimethyldiethoxysilane, diisopropyldimethoxysilane, t-butylmethyldimethoxysilane, t-butylmethyldiethoxysilane, t-amylmethyldiethoxysilane, diphenyldimethoxysilane, phenylmethyldimethoxysilane, diphenyldiethoxysilane, bis-o-tolyldimethoxysilane, bis-m-tolyldimethoxysilane, bis-p-tolyldimethoxysilane, bis-p-tolyldiethoxysilane, bisethylphenyldimethoxysilane, dicyclopentyldimethoxysilane, dicyclohexyldimethoxysilane, cyclohexylmethyldimethoxysilane, cyclohexylmethyldiethoxysilane, ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, γ-chloropropyltrimethoxysilane, methyltriethoxysilane, vinyltriethoxysilane, t-butyltriethoxysilane, thexyltrimethoxysilane, n-butyltriethoxysilane, iso-butyltriethoxysilane, phenyltriethoxysilane, γ-aminopropyltriethoxysilane, chlorotriethoxysilane, ethyltriisopropoxysilane, vinyltributoxysilane, cyclohexyltrimethoxysilane, cyclohexyltriethoxysilane, 2-norbornanetrimethoxysilane, 2-norbornanetriethoxysilane, 2-norbornanemethyldimethoxysilane, ethyl silicate, butyl silicate, trimethylphenoxysilane, methyltriallyloxysilane, vinyltris(β-methoxyethoxysilane), vinyltriacetoxysilane, dimethyltetraethoxydisiloxane, methyl(3,3,3-trifluoro-n-propyl)dimethoxysilane, cyclohexylethyldimethoxysilane, cyclopentyl-t-butoxydimethoxysilane, diisobutyldimethoxysilane, isobutylisopropyldimethoxysilane, n-propyltrimethoxysilane, di-n-propyldimethoxysilane, t-butylethyldimethoxysilane, t-butylpropyldimethoxysilane, t-butyl-t-butoxydimethoxysilane, isobutyltrimethoxysilane, cyclohexylisobutyldimethoxysilane, di-sec-butyldimethoxysilane, isobutylmethyldimethoxysilane, bis(decahydroisoquinolin-2-yl)dimethoxysilane, diethylaminotriethoxysilane, dicyclopentyl-bis(ethylamino)silane, tetraethoxysilane, tetramethoxysilane and isobutyltriethoxysilane, t-butyltrimethoxysilane, i-butyltrimethoxysilane, i-butyl sec-butyldimethoxysilane, ethyl(perhydroisoquinolin-2-yl) dimethoxysilane, tri(isopropenoxy)phenylsilane, i-butyl i-propyldimethoxysilane, cyclohexyl-1-butyldimethoxysilane, cyclopentyl-1-butyldimethoxysilane, cyclopentyl isopropyldimethoxysilane, phenylmethyldimethoxysilane, phenyltriethoxysilane, and p-olylmethyl dimethoxysilane.

In some embodiments, the organosilicon compound is selected from the group consisting of ethyltriethoxysilane, n-propyltriethoxysilane, n-propyltrimethoxysilane, t-butyltriethoxysilane, t-butylmethyldimethoxysilane, t-butylmethyldiethoxysilane, t-butylethyldimethoxysilane, t-butylpropyldimethoxysilane, t-butyl-t-butoxydimethoxysilane, t-butyltrimethoxysilane, i-butyltrimethoxysilane, isobutylmethyldimethoxysilane, i-butyl-sec-butyldimethoxysilane, ethyl(perhydroisoquinolin-2-yl)dimethoxysilane, bis(decahydroisoquinolin-2-yl)dimethoxysilane, tri(isopropenyloxy)phenylsilane, thexyltrimethoxysilane, vinyltriethoxysilane, phenyltriethoxysilane, phenyltrimethoxysilane, vinyltributoxysilane, diphenyldimethoxysilane, diisopropyldimethoxysilane, diisobutyldimethoxysilane, i-butyl-1-propyldimethoxysilane, cyclopentyl-t-butoxydimethoxysilane, dicyclopentyldimethoxysilane, cyclohexylmethyldimethoxysilane, cyclohexyl-1-butyldimethoxysilane, cyclopentyl-1-butyldimethoxysilane, cyclopentylisopropyldimethoxysilane, di-sec-butyldimethoxysilane, diethylaminotriethoxysilane, tetraethoxysilane, tetramethoxysilane, isobutyltriethoxysilane, phenylmethyldimethoxysilane, phenyltriethoxysilane, bis-p-tolyldimethoxysilane, p-tolylmethyldimethoxysilane, dicyclohexyldimethoxysilane, cyclohexylethyldimethoxysilane, 2-norbornanetriethoxysilane, 2-norbornanemethyldimethoxysilane, diphenyldiethoxysilane, and methyl(3,3,3-trifluoro-n-propyl)dimethoxysilane, ethyl silicate.

(4) Polymerization

Raw material monomers are brought into contact with the catalyst, thereby causing the polymerization. In some embodiments, a pre-polymerization occurs using the catalyst. The pre-polymerization is a step of forming a polymer chain as a scaffold of the subsequent final polymerization of the raw material monomers on the solid catalyst component. In some embodiments, the pre-polymerization is performed at 40° C. or less, alternatively 30° C. or less, alternatively 20° C. or less. Subsequently, the catalyst after pre-polymerization (pre-polymerized catalyst) is introduced into a polymerization reaction system for the final polymerization of the raw material monomers. In some embodiments, the polymerization is performed in a liquid phase, a gas phase or a liquid-gas phase. In some embodiments, the polymerization temperature is ambient temperature to 150° C., alternatively 40° C. to 100° C. In some embodiments, the polymerization pressure is in the range from 3.3 to 6.0 MPa for the polymerization in a liquid phase. In some embodiments, the polymerization pressure is in the range from 0.5 to 3.0 MPa for the polymerization in a gas phase. In some embodiments, a molecular weight adjusting agent is used. In some embodiments, the molecular weight adjusting agent is a chain transfer agent selected from the group consisting of hydrogen and ZnEt₂.

In some embodiments, a polymerization reactor having gradient in the monomer concentration and the polymerization conditions is used. In some embodiments, at least two polymerization areas are connected to achieve polymerization of monomers through gas-phase polymerization. In some embodiments and in the presence of a catalyst, the monomers are supplied to the polymerization area of a riser. In some embodiments and in the presence of a catalyst, the monomers are supplied to the polymerization area of a downcomer connected to the riser. In some embodiments, a polymer product, which is circulated through the riser and the downcomer, is collected. In some embodiments, a gas mixture present in the riser is thoroughly or partially prevented from entering the downcomer. In some embodiments, a gas or liquid mixture having a composition different from the gas mixture present in the riser is introduced into the downcomer. In some embodiments, the polymerization method is as described in Japanese Patent Publication No. JP 2002-520426A.

3. Application

In some embodiments, the polypropylene composition is a resin composition for injection molding.

1) Stiffness (flexural modulus): JIS K6921-2

In some embodiments, the polypropylene composition has a flexural modulus of 700 MPa or more, alternatively 800 MPa or more, alternatively 900 MPa or more.

2) Impact resistance at low temperature (Charpy impact strength at −20° C.: JIS K6921-2)

In some embodiments, the polypropylene composition has a Charpy impact strength at −20° C. of 5.0 kJ/m² or more, alternatively 5.5 kJ/m² or more, alternatively 6.0 kJ/m² or more.

In some embodiments, the polypropylene composition is used as automobile interior materials and food packaging materials. In some embodiments, the propylene composition is injection molded, thereby making directly make a product. In some embodiments, the propylene composition is injection molded, thereby making a thin molded article. In some embodiments, the thin molded article is a sheet, which is then subjected to secondary processing such as vacuum forming and pressure forming, thereby making a product.

### EXAMPLES

### Example 1

A solid catalyst composed of Ti and diisobutylphthalate as an internal donor supported on MgCl₂ was prepared as described in lines 46 to 53 in Example 5 of European Patent Publication No. 728769.

Microspheroidal MgCl₂.2.1C₂H₅OH was produced in the following manner. Under an inert gas at ambient temperature, 48 g of anhydrous MgCl₂, 77 g of anhydrous C₂H₅OH and 830 mL of kerosene were put in a 2-L autoclave having a turbine stirrer and a suction pipe. While stirring, the content was heated to 120° C., thereby forming an adduct between MgCl₂ and the alcohol. The adduct was melted and mixed with a dispersant. The nitrogen pressure in the autoclave was maintained at 15 atm. The suction pipe of the autoclave was heated to 120° C. from the outside with use of a heating jacket. The suction pipe had an inner diameter of 1 mm, and a length of 3 m from one end to the other end of the heating jacket. Through the pipe, the mixture flowed at a rate of 7 m/sec. At an outlet of the pipe, the dispersion was collected in a 5-L flask containing 2.5 L of kerosene while stirring, and being cooled from the outside with a jacket of which initial temperature was maintained at −40° C. The final temperature of the dispersion was 0° C. A spherical solid product constituting the dispersed phase of the emulsion was sedimentation-precipitated, separated by filtration, washed with heptane, and dried. The operations were performed in an inert gas atmosphere. Solid spherical particle MgCl₂.3C₂H₅OH having a maximum diameter of 50 μm or less was thereby obtained. The yield was 130 g. From the resulting product, alcohol was removed until the alcohol content decreased to 2.1 mol per mole of MgCl₂, by gradually raising temperature from 50° C. to 100° C. in a nitrogen stream.

In a 500-mL cylindrical glass reactor having a filtration barrier, 225 mL of TiCl₄ was put at 0° C., and further, 10.1 g (54 mmol) of microspheroidal MgCl₂.2.1C₂H₅OH was put therein over 15 minutes while stirring the content. The temperature was then raised to 40° C., and 9 mmol of diisobutylphthalate was put therein. The temperature was raised to 100° C. over 1 hour and stirring was continued for a further 2 hours. Subsequently, TiCl₄ was removed by filtration. While stirring for a further 1 hour at 120° C., 200 mL of TiCl₄ was added. Finally, the content was filtered and washed with n-heptane at 60° C. until total extinction of chlorine ions from the filtrate. The resulting catalyst component contained 3.3% by weight of Ti and 8.2% by weight of diisobutylphthalate.

Subsequently, the solid catalyst component, triethylaluminium (TEAL) as an organoaluminum compound, and dicyclopentyldimethoxysilane (DCPMS) as an external electron donor compound were brought into contact to each other at a weight ratio of TEAL to the solid catalyst of 20 and a weight ratio of TEAL to DCPMS of 10, at 12° C. for 24 minutes, thereby obtaining a catalyst.

The resulting catalyst was maintained in a suspension state in liquid propylene at 20° C. for 5 minutes for pre-polymerization to proceed, thereby forming a prepolymer. The resulting prepolymer was introduced to a first-stage polymerization reactor of a polymerization unit having two-stage polymerization reactors in series, and propylene was further supplied thereto for the polymerization to proceed, thereby producing a propylene homopolymer as component (1). The propylene homopolymer as component (1) in powder form had an average particle size of 2.2 mm and an average pore diameter of 9.4 μm. To a second-stage polymerization reactor, the propylene homopolymer, ethylene and propylene were supplied for the polymerization to proceed, thereby producing an ethylene/propylene copolymer as component (2). A first polymer consisting of component (1) and component (2) was obtained.

During polymerization, the temperature and the pressure were adjusted, and hydrogen was used as a molecular weight adjusting agent. In the first-stage polymerization reactor, the polymerization temperature and hydrogen concentration were 70° C. and 2.85 mol %, respectively. In the second-stage polymerization reactor, the polymerization temperature, the hydrogen concentration, and the molar ratio C2/(C2+C3) were 80° C., 1.52 mol %, and a molar ratio of 0.44, respectively. As used herein, “C2” and “C3” represent ethylene and propylene, respectively. The residence time distribution between the first-stage and the second-stage was adjusted to have a ratio of the ethylene/propylene copolymer component as component (2) to the polypropylene polymer consisting of component (1) and component (2), that is, component (2)/[component (1)+component (2)], of 34.2% by weight. The data on the characteristics of component (1), component (2) and the polymer consisting of component (1) and component (2) are shown in Table 1.

To 100 parts by weight of a polymer consisting of component (1) and component (2), 0.25 parts by weight of B225 manufactured by BASF as an antioxidant, 0.05 parts by weight of DHT-4A manufactured by Kyowa Chemical Industry Co., Ltd. as a neutralizer, 0.2 parts by weight of ADEKASTAB LA502XP manufactured by ADEKA Corporation as a weathering stabilizer, 0.2 parts by weight of ADEKASTAB NA18 manufactured by ADEKA Corporation as a nucleating agent, and 0.1 parts by weight of glycerol monostearate as an antistatic agent were added. The mixture was stirred with a Henschel mixer for 1 minutes. The mixture was melt-kneaded and extruded with a co-rotating twin-screw extruder having a screw diameter of 15 mm manufactured by Technovel Corporation, at a cylinder temperature of 230° C. The strand was cooled in water and then cut by a pelletizer, thereby yielding a polypropylene composition made from or containing the first polymer, in a pellet form.

### Example 2

A polypropylene composition was produced and evaluated in the same manner as in Example 1, except that the hydrogen concentration in the first-stage reactor was changed to 2.51 mol %, the hydrogen concentration in the second-stage reactor was changed to 2.04 mol %, and the molar ratio C2/(C2+C3) in the second-stage reactor was changed to 0.45. The residence time distribution in the first-stage and the second-stage was adjusted to have component(2)/[component (1)+component (2)] of 34.4% by weight.

### Example 3

A polypropylene composition was produced and evaluated in the same manner as in Example 2, except that the hydrogen concentration in the first-stage reactor was changed to 1.50 mol %, and the hydrogen concentration in the second-stage reactor was changed to 3.31 mol %. The residence time distribution in the first-stage and the second-stage was adjusted to have component(2)/[component (1)+component (2)] of 34.6% by weight.

### Comparative Example 1

A solid catalyst composed of Ti and diisobutylphthalate as an internal donor supported on MgCl₂ was prepared as described in lines 21 to 36 in paragraph 32 of Japanese Patent Publication No. JP2004-27218A.

Under nitrogen atmosphere at 120° C., 56.8 g of anhydrous magnesium chloride was dissolved in 100 g of anhydrous ethanol, 500 mL of Vaseline oil “CP15N” manufactured by Idemitsu Kosan Co. Ltd., and 500 mL of silicone oil “KF96” manufactured by Shin-Etsu Chemical Co., Ltd. The solution was stirred with a T. K. Homomixer manufactured by PRIMIX Corporation at 120° C. and 5000 rpm for 2 minutes. While stirring, the solution was poured into 2 L of anhydrous heptane, maintaining the temperature under 0° C. The resulting white solid was washed with anhydrous heptane, vacuum dried at room temperature, and ethanol was partially removed under nitrogen stream, thereby obtaining 30 g of spherical solid of MgCl₂.1.2C₂H₅OH.

In 200 mL of anhydrous heptane, 30 g of spherical solid of MgCl₂.1.2C₂H₅OH was suspended. While stirring at 0° C., 500 mL of titanium tetrachloride was placed therein over 1 hour. Subsequently, after the suspension was heated to 40° C., 4.96 g of diisobutylphthalate was added thereto, and the temperature was raised to 100° C. in about 1 hour. After the reaction at 100° C. for 2 hours, the solid portion was collected by hot filtration. Then, 500 mL of titanium tetrachloride was added to the reactant. After stirring, the reaction proceeded at 120° C. for 1 hour. After the reaction, the solid portion was collected by hot filtration and washed seven times with 1.0 L of hexane at 60° C. and three times with 1.0 L of hexane at room temperature, thereby obtaining a solid catalyst component. The titanium content in the solid catalyst component was 2.36% by weight.

With use of the solid catalyst, a polypropylene composition was produced and evaluated in the same manner as in Example 1, except that the hydrogen concentration in the first-stage reactor was changed to 1.75 mol %, the hydrogen concentration and the molar ratio C2/(C2+C3) in the second-stage reactor were changed to 1.88 mol % and a molar ratio of 0.21, respectively. The residence time distribution in the first-stage and the second-stage was adjusted to have component(2)/[component (1)+component (2)] of 28.4% by weight. The propylene homopolymer component (1) in a power form produced by the process had an average particle size of 1.2 mm and average pore diameter of 7.0 μm.

### Comparative Example 2

A polypropylene composition was produced and evaluated in the same manner as in Example 3, except that the hydrogen concentration in the first-stage reactor was changed to 1.17 mol %. The residence time distribution in the first-stage and the second-stage was adjusted to have component(2)/[component (1)+component (2)] of 28.3% by weight.

TABLE 1

| | | | Comparative | |
|---|---|---|---|---|
| Example | | | Example | |
| 1 | 2 | 3 | 1 | 2 |

Component (1), component (2), and polymer
consisting of component (1) and component (2)

| | | | | | | |
|---|---|---|---|---|---|---|
| MFR of component (1) | g/10 min | 283 | 229 | 94 | 126 | 65 |
| XI of component (1) | % by weight | 98.1 | 98.1 | 98.1 | 98.0 | 98.1 |
| Mw/Mn of XI of | — | 5.5 | 5.5 | 5.5 | 5.5 | 5.5 |
| component (1) | | | | | | |
| Average pore diameter | μm | 9.4 | 9.4 | 9.4 | 7.0 | 9.4 |
| (Dn) of component (1) | | | | | | |
| Average particle size | mm | 2.2 | 2.2 | 2.2 | 1.2 | 2.2 |
| (diameter) of component (1) | | | | | | |
| Ethylene-derived unit of | % by weight | 45.2 | 46.4 | 46.2 | 27.5 | 46.2 |
| component (2) | | | | | | |
| Component (2)/[component | % by weight | 34.2 | 34.4 | 34.6 | 28.4 | 28.3 |
| (1) + component(2)] | | | | | | |
| XSIV of [component (1) + | dl/g | 2.6 | 2.2 | 1.7 | 2.3 | 1.7 |
| component (2)] | | | | | | |
| MFR of [component (1) + | g/10 min | 30 | 36 | 32 | 30 | 33 |
| component (2)] | | | | | | |
| Powder flowability of | — | 1.5 | 1.8 | 2.0 | 1.5 | 1.5 |
| [component (1) + | | | | | | |
| component (2)] | | | | | | |

Polypropylene composition in pellet form

| | | | | | | |
|---|---|---|---|---|---|---|
| [Component (1) + | Part by weight | 100 | 100 | 100 | 100 | 100 |
| component (2)] | | | | | | |
| Additive | Part by weight | 0.8 | 0.8 | 0.8 | 0.8 | 0.8 |

Molded article

| | | | | | | |
|---|---|---|---|---|---|---|
| Flexural modulus | MPa | 1,100 | 1,110 | 1,130 | 1,230 | 1,290 |
| Charpy impact | kJ/m² | 6.5 | 5.7 | 5.4 | 4.5 | 3.7 |
| strength −20° C. | | | | | | |

[Measurement Condition]

1) MFR

To 5 g of a powder sample, 0.05 g of H-BHT manufactured by Honshu Chemical Industry Co., Ltd. was added. After homogenization by dry blending, measurement was performed under conditions at a temperature of 230° C. and under a load of 2.16 kg in accordance with JIS K6921-2.

2) XI of Component (1)

While stirring, 2.5 g of a polymer was dissolved in 250 mL of xylene at 135° C. After 20 minutes, the solution was cooled to 25° C. while stirring, and then left standing still for 30 minutes. The precipitate was filtered with a filter paper. The solution was evaporated in a nitrogen stream. The residue was dried to a specific weight under vacuum at 80° C. The % by weight of polymers soluble in xylene at 25° C. was calculated. The amount of xylene insolubles (% by weight of polymers insoluble in xylene at 25° C., XI) is determined from 100-“% by weight of soluble polymers”, which is presumed as the amount of isotactic components of the polymer. To collect xylene insolubles, the precipitate was washed with methanol to remove the remaining xylene and then dried under vacuum at 80° C.

3) Mw/Mn of XI Component of Component (1)

The xylene insolubles was subjected to measurement of molecular weight distribution (Mw/Mn). PL GPC220 manufactured by Polymer Laboratories Ltd. was used as apparatus, 1,2,4-trichlorobenzene containing an antioxidant was used as mobile phase, one UT-G, one UT-807 and two UT-806M manufactured by Showa Denko K.K. were connected in series for use as a column, and a differential refractometer was used as detector. The solvent of the solution was the same as the mobile phase. Through dissolution at a concentration of 1 mg/mL for 2 hours while shaking at a temperature of 150° C., a sample for measurement was prepared. Into the column, 500 μL of the sample solution was injected for measurement at a flow rate of 1.0 mL/min, at a temperature of 145° C., and at an interval of data acquisition of 1 second. The calibration of the column was made through a cubic spline with use of a polystyrene standard (SHODEX STANDARD manufactured by Showa Denko K.K.), having a molecular weight of 5800000 to 7450000. As Mark-Houwink-Sakurada coefficients, K=1.21×10⁻⁴ and α=0.707 were used for the polystyrene standard, and K=1.37×10⁻⁴ and α=0.75 were used for the propylene homopolymer, and the polypropylene made from or containing the propylene random copolymer.

4) Average Particle Size and Average Pore Diameter of Component (1)

The bulk density of component (1) was measured with a full-automatic pore distribution measurement apparatus PORE MASTER 60-GT manufactured by Quanta Chrome Corporation. The average particle size of component (1) was obtained by measuring the number of particles per gram to determine the average weight per piece, determining the average volume per piece from the bulk density, and calculating the average diameter as a sphere from the average volume. Also, using the same apparatus, the distribution of pore diameter D was measured in the range of 1 μm to 100 μm by the mercury intrusion method according to JIS R1655 to calculate the average pore diameter Dn from the following equation:

Dn=∫(−dV/d log D)d log D/∫(1/D)(−dV/d log D)d log D

wherein V represents the sample volume, which corresponds to the subtraction of pore volume from volume (bulk volume) of each particle.

5) Ethylene-Derived Unit of Component (2)

A ¹³C-NMR spectrum of the sample dissolved in a mixed solvent of 1,2,4-trichlorobenzen and deuterated benzene was obtained by using AVANCE III HD400 (¹³C resonance frequency: 100 MHz) manufactured by Bruker Corporation, under conditions of a measurement temperature of 120° C., a flip angle of 45 degrees, a pulse interval of 7 seconds, a sample rotation number of 20 Hz, and a cumulative number of 5000.

From the resulting spectrum, a total amount of ethylene (% by weight) in the first polymer consisting of component (1) and component (2) was determined by the method described in literature: Kakugo, Y. Naito, K. Mizunuma and T. Miyatake, Macromolecules 15, 1150-1152 (1982). The ethylene content (% by weight) in component (2) was obtained, except that the integrated intensity T′ββ obtained from the following equation was used instead of the integrated intensity Tββ obtained in the measurement of the total amount of ethylene:

T′ββ=0.98×Sαγ×A/(1−0.98×A)

wherein A=Sαγ/(Sαγ+Sαδ) is calculated from Sαγ and Sαδ.

6) Weight Ratio Component (2)/[Component (1)+Component (2)]

The content of component (2) relative to the total weight of component (1) and component (2) was determined from the following equation:

Content (% by weight) of component (2)=[total ethylene content of polymer consisting of component (1) and component (2)/ethylene content in component (2)]×100

7) Intrinsic Viscosity (XSIV) of [Component (1)+Component (2)]

Xylene solubles in the first polymer consisting of component (1) and component (2) was obtained, thereby measuring the intrinsic viscosity (XSIV) of the xylene solubles.

2.5 g of a sample of the first polymer consisting of component (1) and component (2) was added to a flask containing 250 mL of o-xylene (solvent). The solvent was stirred for 30 minutes at 135° C. while purging nitrogen by using a hot plate and a reflux device, thereby dissolving the polymer. The solution was cooled at 25° C. for 1 hour. The resulting solution was filtered with a filter paper. After the filtration, 100 mL of the filtrate was collected, transferred into an aluminum cup or the like, subjected to evaporation to dryness at 140° C. while purging nitrogen, and left standing still for 30 minutes at room temperature, thereby obtaining xylene solubles.

The intrinsic viscosity was measured in tetrahydronaphthalene at 135° C., using an automatic capillary viscometer (SS-780-H1, manufactured by Shibayama Scientific Co., Ltd.).

8) Powder Flowability

On a metal plate, a metal frame having an opening with a length of 5 cm, a width of 5 cm, and a height of 1 cm was placed. In the metal frame, 5 g of the first polymer consisting of component (1) and component (2) was spread. A metal lid having a weight of 0.92 g was placed in the metal frame. A uniform pressure of 23 g/cm² was applied to the first polymer. After the first polymer in the metal frame was held at 70° C. for 20 minutes, the metal frame and the metal lid were removed. The metal plate was tilted to make the following 5-grade evaluation 4 times for calculation of the average.

1: The total volume of first polymer collapsed when the substrate was tilted at 0° or more and less than 30°.

2: The total volume of first polymer collapsed when the substrate was tilted at 300 or more and less than 50°.

3: The total volume of first polymer collapsed when the substrate was tilted at 500 or more and less than 70°.

4: The total volume of first polymer collapsed when the substrate was tilted at 70° or more and less than 90°.

5: No total volume collapse occurred even when the substrate was tilted at 900 or more.

The metal plate, the metal frame and the metal lid were made of stainless steel SUS 304. The surface of the metal plate for use was #400-grit polished (sisal finish) to have a surface roughness (maximum roughness Ry) of 0.2 μm.

9) Flexural Modulus

The measurement was made in accordance with JIS K6921-2. Specifically, in accordance with JIS K7171, a polypropylene composition was subjected to injection molding using an injection molding machine (FANUC ROBOSHOT 52000i manufactured by FANUC Corporation) under conditions of a molten resin temperature of 200° C., a mold temperature of 40° C., an average injection rate of 200 mm/s, a holding time of 40 seconds, and a total cycle time of 60 seconds, thereby making a multi-purpose test piece (type A1) specified in JIS K7139. The resulting molded article was processed to have a width of 10 mm, a thickness of 4 mm, and a length of 80 mm, thereby obtaining a measurement test piece (type B2). The flexural modulus of the test piece of type B2 was measured using a precision universal tester (AUTOGRAPH AG-X 10 kN manufactured by Shimadzu Corporation), under conditions of a temperature of 23° C., a relative humidity of 50%, a distance between supporting points of 64 mm, and a testing speed of 2 mm/min.

10) Charpy Impact Strength

In accordance with JIS K6921-2, a test piece of type A1 obtained in the same operation as for the test piece for use in the flexural modulus was measured. Specifically, in accordance with JIS K7111-1, after processing to have a width of 10 mm, a thickness of 4 mm, and a length of 80 mm, a 2-mm notch was made in the width direction, using a notching tool A-4 manufactured by Toyo Seiki Seisaku-sho, Ltd., thereby obtaining a measurement test piece having a shape A. The Charpy impact strength (edgewise impact, method 1 eA) of the test piece was measured using a full-automatic impact tester having a cryostat (No. 258-ZA) manufactured by Yasuda Seiki Seisakusho Ltd., under conditions of a temperature of −20° C.

What is claimed is:

1. A polypropylene composition comprising:
a first polymer consisting of
component (1) comprising a propylene homopolymer having 80 to 300 of MFR (at a temperature of 230° C. under a load of 2.16 kg) and containing more than 97.5% by weight of xylene insolubles (XI), wherein XI of the propylene homopolymer has a Mw/Mn of 4 to 10 as measured by GPC; and
component (2) comprising an ethylene/propylene copolymer containing 35 to 50% by weight of an ethylene-derived unit;
wherein the polypropylene composition has the following characteristics:
1) the relative proportion of component (2)/[component (1) and component (2)] is, more than 30% by weight and not more than 50% by weight,
2) the intrinsic viscosity of xylene solubles (XSIV) of the first polymer is in the range of 1.5 to 4.0 dl/g, and
3) the MFR (at a temperature of 230° C. under a load of 2.16 kg) of the first polymer is in the range of 20 to 100 g/10 min.

2. A polypropylene composition according to claim 1,
wherein
component (1) is porous particles having an average particle diameter of 1.5 to 4.0 mm and an average pore diameter (Dn) of 8 to 50 μm; and
the first polymer is a powder, wherein the flowability of the powder is equal or less than 3.5.

3. A pellet-shaped polypropylene composition produced from the polypropylene composition according to claim 1.

4. A molded article obtained by injection molding the polypropylene composition according to claim 1.
